(19) United States
(12) Patent Application Publication
(10) Pub. No.: US 2006/0249599 A1
(43) Pub. Date: Nov. 9, 2006

(54) Control device for fluid dispenser

(76) Inventor: Wen Li Guo, Changhua Hsien (TW)

Correspondence Address: CHARLES E. BAXLEY, ESQ., 90 JOHN STREET, THIRD FLOOR, NEW YORK, NY, 10038, US

(21) Appl. No.: 11/240,108

(22) Filed: Sep. 30, 2005

(30) Foreign Application Priority Data
Apr. 20, 2005 (CN) 200510025219.8

(51) Int. Cl. B05B 9/08

(52) U.S. Cl. 239/530; 239/525; 239/581.1

(57) ABSTRACT

A fluid dispenser includes a handle having a valve seat and a compartment, a valve member slidably received in the handle, for selectively engaging with the valve seat of the handle, to selectively enclose and block the bore of the handle. A spring member may bias the valve member to engage with the valve seat of the handle. A control member is rotatably engaged in the compartment of the handle, and includes an actuator for engaging with the valve member, and for selectively moving the valve member away from the valve seat of the handle when the control member is rotated relative to the handle. The control member includes an axle rotatably secured to a casing of the handle.

### BACKGROUND OF THE INVENTION

1. Field of the Invention

The present invention relates to a trigger or control device, and more particularly to a trigger or control device having a simplified configuration for easily controlling a spraying gun or spraying facility or fluid dispenser or the like.

2. Description of the Prior Art

Typical spraying guns or facilities comprise a trigger or control device attached to a handle thereof, for triggering or controlling the water to flow into the spraying guns or facilities, or to stop the water from flowing into the spraying guns or facilities, and normally including a hand grip pivotally attached or coupled to the handle thereof, to control the spraying guns or facilities.

For example, U.S. Pat. No. 4,534,512 to Chow et al. discloses one of the typical fluid dispensers comprising a handle pivotally mounted on the hose nozzle body and adapted for movement between a no flow position and a full open position. Normally, the handle is depressed toward a grip of the hose nozzle body while operating the typical fluid dispensers, such that the handle may not be micro-adjusted relative to the grip of the hose nozzle body while operating the typical fluid dispensers.

U.S. Pat. No. 4,903,897 to Hayes discloses another typical hose nozzle comprising an actuating member coupled to a ball valve, in order to rotate the ball valve relative to a tubular body of the hose nozzle. The actuating member should be rotated laterally or sidewise relative to the tubular body with the side portions of the thumb of the user. However, the side portions of the thumb of the user may be hurt by the nail of the thumb while depressing or rotating the actuating member relative to the tubular body with the side portions of the thumb of the user.

The present invention has arisen to mitigate and/or obviate the afore-described disadvantages of the conventional control devices for fluid dispensers or spraying guns.

### SUMMARY OF THE INVENTION

The primary objective of the present invention is to provide a control device including a simplified configuration for easily controlling a spraying gun or facility or a fluid dispenser or other nozzles.

In accordance with one aspect of the invention, there is provided a fluid dispenser comprising a handle including a bore formed therein, and including a first end for coupling to a water reservoir, to receive water therefrom, and including a second end having a valve seat provided therein, and having a compartment formed therein and communicating with the bore of the handle, for allowing the water to flow into the compartment of the handle, a valve member slidably received in the bore of the handle, for selectively engaging with the valve seat of the handle, to selectively enclose and block the bore of the handle, a spring biasing device for biasing the valve member to engage with the valve seat of the handle, and a control member rotatably engaged in the compartment of the handle, and including an actuator extended therefrom, for engaging with the valve member, and for selectively moving the valve member away from the valve seat of the handle when the control member is rotated relative to the handle.

The control member includes an arm extended therefrom, and a knob provided on the arm, for operating the control member. The handle includes a cover attached to the second end thereof, and having a channel formed therein, to slidably receive the arm of the control member.

The handle includes a projection extended from the second end thereof, and partially extended into the channel of the cover. The handle includes a casing to define the compartment therein, the cover includes two protrusions provided therein, for engaging with the casing and the control member, to stably retain and position the control member within the casing.

The control member includes an axle extended therefrom, and rotatably secured to the handle. The handle includes a casing to define the compartment therein, and having a socket provided in an end wall thereof, for rotatably receiving the axle. The control member includes an outer peripheral groove formed therein, and a sealing ring engaged in the outer peripheral groove of the control member and engaged between the control member and the casing, for making a water tight seal between the control member and the casing.

The valve member includes an extension extended therefrom and extended into the compartment of the casing, for engaging with the actuator of the control member. The handle includes a stop secured in the bore thereof, and the biasing device includes a spring member engaged between the valve member and the stop, to bias the valve member to engage with the valve seat of the handle. The stop includes at least one passage formed therein, for allowing the water to flow through the passage of the stop.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is an exploded view of a control device for a fluid dispenser in accordance with the present invention;

FIG. 2 is a cross sectional view of the fluid dispenser, taken along lines 2-2 of FIG. 3;

FIG. 3 is a cross sectional view of the fluid dispenser, taken along lines 3-3 of FIG. 2;

FIG. 4 is a partial cross sectional view taken along lines 4-4 of FIG. 3;

FIG. 5 is a cross sectional view similar to FIG. 2, illustrating the operation of the control device for the fluid dispenser;

FIG. 6 is a cross sectional view similar to FIGS. 2 and 5, illustrating the application of the control device for the fluid dispenser; and

FIGS. 7 and 8 are cross sectional views similar to FIG. 6, illustrating the other applications of the control device for the fluid dispenser.

### DETAILED DESCRIPTION OF THE PREFERRED EMBODIMENT

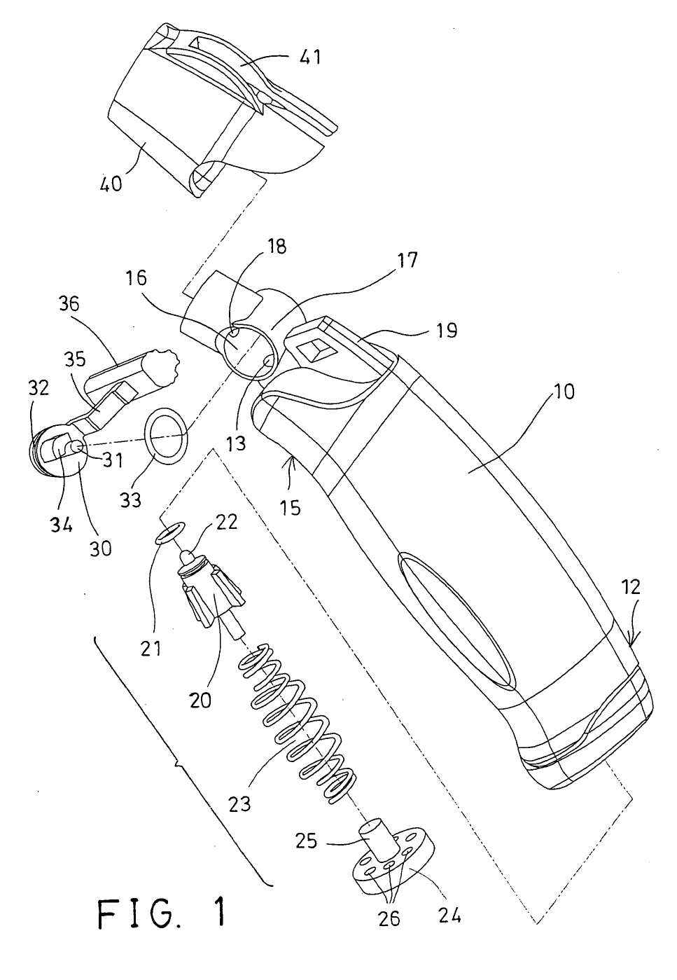

Referring to the drawings, and initially to FIGS. 1-4, a fluid dispenser in accordance with the present invention comprises a dispenser body or handle 10 including a bore 11 formed therein, and including one end 12 for coupling to a water reservoir, in order to receive the water and to allow the water to flow into the bore 11 thereof, and including an opening 13 and a valve seat 14 formed or provided on the other end 15 thereof, for the water to flow out of the handle 10.

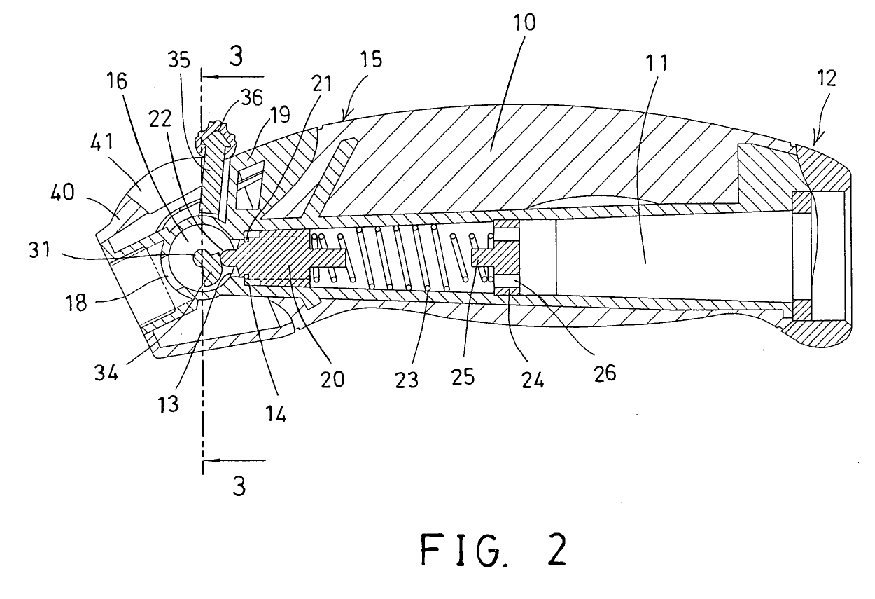

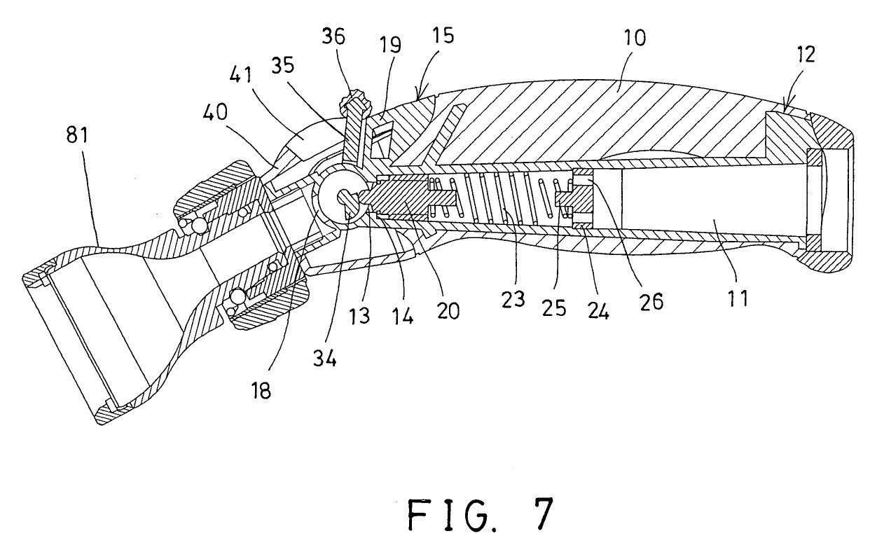

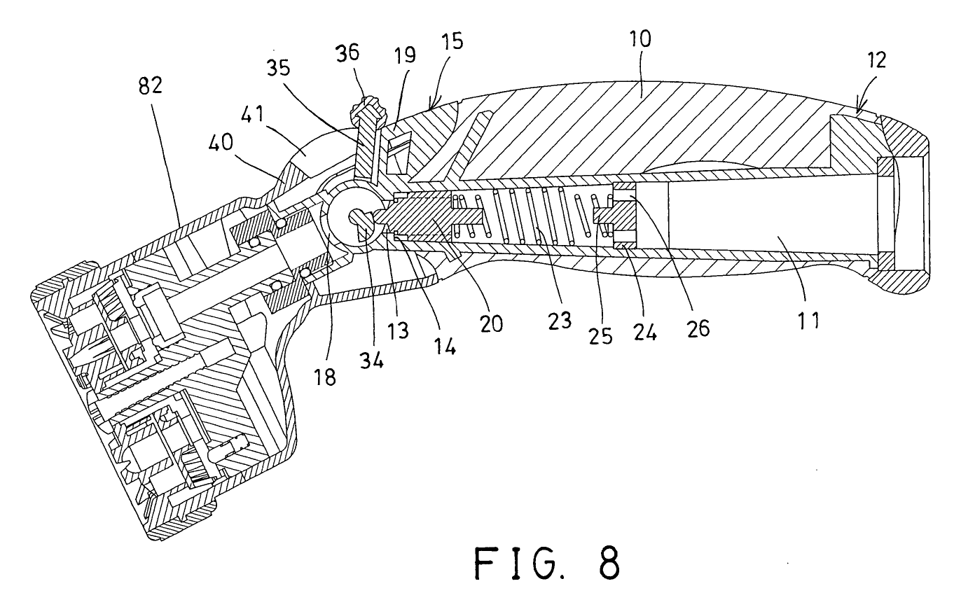

A valve member 20 is slidably received in the bore 11 of the handle 10, and includes a sealing ring 21 attached to one end thereof, for engaging with the valve seat 14 of the handle 10, and for selectively enclosing or blocking or opening the opening 13 of the handle 10. The valve member 20 includes an extension 22 extended from the one end thereof, and extended out through the opening 13 of the handle 10 (FIGS. 2 and 5-8). A spring biasing means or a spring member 23 may be engaged onto the valve member 20, to bias and to force the valve member 20 to engage with the valve seat 14 of the handle 10.

It is preferable that a stop 24 is engaged in the bore 11 of the handle 10, and secured to the handle 10 with such as force-fitted engagements, fasteners (not shown), or the like, and includes a stud 25 extended therefrom, for engaging into or with the spring member 23, and for positioning or anchoring the spring member 23, and includes one or more passages 26 formed therein, for allowing the water to flow through the passages 26 of the stop 24. The spring member 23 may thus bias and force the valve member 20 to engage with the valve seat 14 of the handle 10.

The handle 10 further includes a compartment 16 formed in the other end 15 thereof, and defined by a casing 17, and communicating with the opening 13 or the bore 11 of the handle 10, for allowing the water to flow into the compartment 16 of the handle 10. The casing 17 includes an outlet port 18 formed therein (FIGS. 1-2 and 5-8), and communicating with the compartment 16 of the handle 10, for allowing the water to flow out of the handle 10. It is preferable that the handle 10 includes a projection 19 extended from the other end 15 thereof. The extension 22 of the valve member 20 is extended into the compartment 16 of the casing 17.

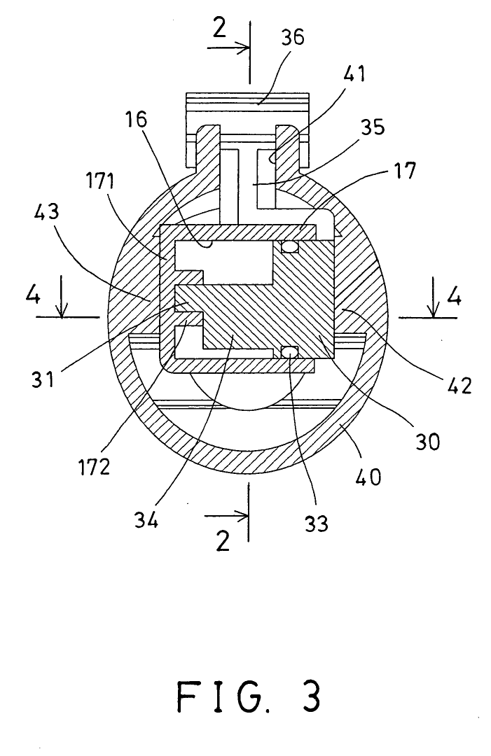

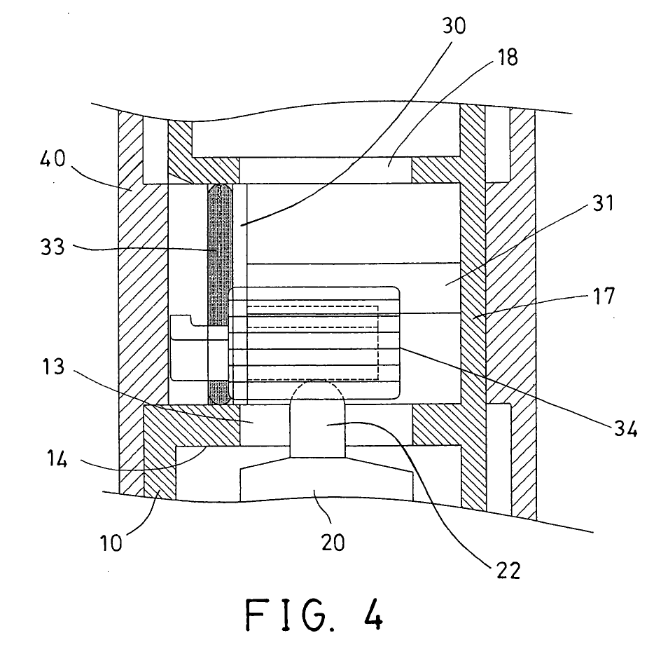

A control member 30 is rotatably engaged in one end of the compartment 16 of the casing 17 of the handle 10, and includes an axle 31 extended therefrom for pivotally or rotatably attached to the casing 17 of the handle 10, best shown in FIG. 3, and includes an outer peripheral groove 32 formed therein, for receiving a sealing ring 33 which may be engaged between the control member 30 and the casing 17 of the handle 10, for making a water tight seal between the control member 30 and the casing 17 of the handle 10, best shown in FIGS. 3 and 4.

For example, as shown in FIG. 3, the casing 17 of the handle 10 includes an end wall 171 having a hub or socket 172 formed or provided therein, for rotatably receiving the axle 31, and thus for rotatably attaching the axle 31 and the control member 30 to the casing 17 of the handle 10. The compartment 16 of the casing 17 of the handle 10 may thus be enclosed by the end wall 171 of the casing 17 and the control member 30, and to guide the water to flow out through the outlet port 18 of the casing 17 of the handle 10 only.

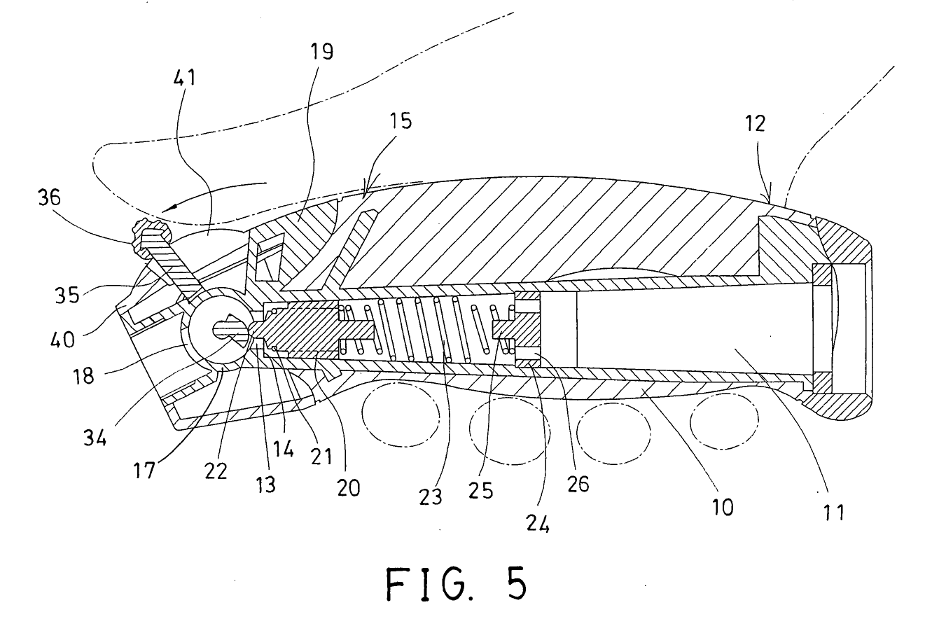

The control member 30 further includes a cam or an actuator 34 extended therefrom, for engaging with the valve member 20, such as for engaging with the extension 22 of the valve member 20, and for selectively moving the valve member 20 away from the valve seat 14 of the handle 10, when the actuator 34 of the control member 30 is rotated relative to the casing 17 of the handle 10 (FIGS. 2, 5). The control member 30 further includes an arm 35 extended therefrom, and a knob 36 formed or provided on the arm 35, for operating the control member 30, or for rotating the control member 30 relative to the casing 17 of the handle 10.

It is preferable that the handle 10 further includes a cover 40 attached or secured onto the other end 15 thereof with such as adhesive materials, fasteners or latches (not shown), or by welding processes, and includes a channel 41 formed therein, in which the projection 19 of the handle 10 is partially extended into the channel 41 of the cover 40. The arm 35 of the control member 30 is rotatably or slidably engaged in the channel 41 of the cover 40. As best shown in FIG. 3, the cover 40 includes two protrusions 42, 43 extended or provided therein, for engaging with the casing 17 and the control member 30, to stably retain and position the control member 30 within the casing 17.

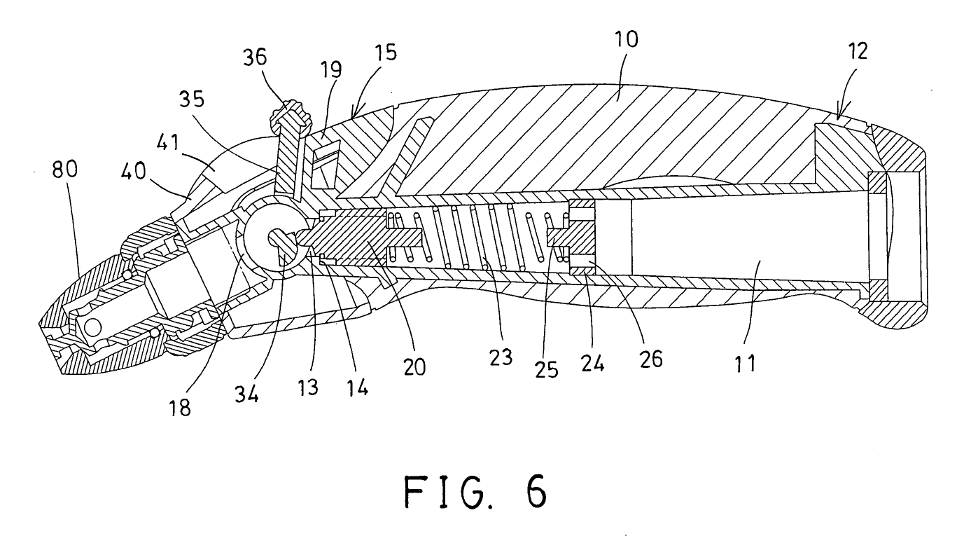

In operation, as shown in FIGS. 2 and 5, the knob 36 of the arm 35 of the control member 30 may be depressed or actuated or operated forwardly and rearwardly by the front or tip portion of the thumb of the user where no finger nail are located, or the finger nail of the user will not be contacted with the knob 36 of the arm 35 of the control member 30, to allow the user to comfortably depress and operate the knob 36 of the arm 35 of the control member 30. As shown in FIGS. 6-8, various kinds of spraying nozzles 80, 81, 82 may be selectively or changeably attached onto the other end 15 of the handle 10, for forming various water spraying patterns.

The conventional fluid dispensers failed to provide a knob 36 of an arm 35 of a control member 30 that may be comfortably depressed and operated forwardly and rearwardly by the thumb of the user, without being depressed and operated by the side portions of the thumb of the user.

Accordingly, the control device for the fluid dispenser in accordance with the present invention includes a simplified configuration for easily controlling a spraying gun or facility or a fluid dispenser or other nozzles.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A fluid dispenser comprising:
a handle including a bore formed therein, and including a first end for coupling to a water reservoir, to receive water therefrom, and including a second end having a valve seat provided therein, and having a compartment formed therein and communicating with said bore of said handle, for allowing the water to flow into said compartment of said handle,
a valve member slidably received in said bore of said handle, for selectively engaging with said valve seat of said handle, to selectively enclose and block said bore of said handle,
means for biasing said valve member to engage with said valve seat of said handle, and
a control member rotatably engaged in said compartment of said handle, and including an actuator extended therefrom, for engaging with said valve member, and for selectively moving said valve member away from said valve seat of said handle when said control member is rotated relative to said handle.

2. The fluid dispenser as claimed in claim 1, wherein said control member includes an arm extended therefrom, and a knob provided on said arm, for operating said control member.

3. The fluid dispenser as claimed in claim 2, wherein said handle includes a cover attached to said second end thereof, and having a channel formed therein, to slidably receive said arm of said control member.

4. The fluid dispenser as claimed in claim 3, wherein said handle includes a projection extended from said second end thereof, and partially extended into said channel of said cover.

5. The fluid dispenser as claimed in claim 3, wherein said handle includes a casing to define said compartment therein, said cover includes two protrusions provided therein, for engaging with said casing and said control member, to stably retain and position said control member within said casing.

6. The fluid dispenser as claimed in claim 1, wherein said control member includes an axle extended therefrom, and rotatably secured to said handle.

7. The fluid dispenser as claimed in claim 6, wherein said handle includes a casing to define said compartment therein, and having a socket provided in an end wall thereof, for rotatably receiving said axle.

8. The fluid dispenser as claimed in claim 7, wherein said control member includes an outer peripheral groove formed therein, and a sealing ring engaged in said outer peripheral groove of said control member and engaged between said control member and said casing, for making a water tight seal between said control member and said casing.

9. The fluid dispenser as claimed in claim 1, wherein said valve member includes an extension extended therefrom and extended into said compartment of said casing, for engaging with said actuator of said control member.

10. The fluid dispenser as claimed in claim 1, wherein said handle includes a stop secured in said bore thereof, and said biasing means includes a spring member engaged between said valve member and said stop, to bias said valve member to engage with said valve seat of said handle.

11. The fluid dispenser as claimed in claim 10, wherein said stop includes at least one passage formed therein, for allowing the water to flow through said at least one passage of said stop.
